(19) United States
(12) Patent Application Publication
(10) Pub. No.: US 2015/0154295 A1
(43) Pub. Date: Jun. 4, 2015

(54) SEARCHING METHOD, SYSTEM AND STORAGE MEDIUM

(71) Applicant: Tencent Technology (Shenzhen) Company Limited, Guangdong (CN)

(72) Inventors: Juan Zhao, Guangdong (CN); Yue Cao, Guangdong (CN); Jiantao Gong, Guangdong (CN); Hejun Ning, Guangdong (CN); Ming Yu, Guangdong (CN)

(21) Appl. No.: 14/412,468

(22) PCT Filed: Sep. 10, 2013
(86) PCT No.: PCT/CN2013/083176

§ 371 Date: Jan. 2, 2015

(30) Foreign Application Priority Data
Sep. 13, 2012 (CN) 201210338491.1

(51) Int. Cl. G06F 17/30

(52) U.S. Cl. CPC G06F 17/30864; G06F 17/30386; G06F 17/30985

(57) ABSTRACT

The present invention refers to a searching method, comprising: getting searching strings inputted by a user in real time; matching the searching strings with first keywords of a searching keywords hint database and second keywords of a through zone database respectively, wherein the searching keywords hint database includes plural first keywords and the through zone database includes plural second keywords and data corresponding to the second keywords; displaying a predefined number of first keywords and a predefined number of second keywords matched with the searching strings to hint; when any first keyword is chosen, displaying searching result pages matched with the first keyword; when any second keyword is chosen, displaying data matched with the second keyword in through database. The present invention also refers to a searching system and storage medium which can efficiently improve searching efficiency.

### CROSS-REFERENCE TO RELATED APPLICATIONS

This application claims the benefit of priority to Chinese Patent Application No. 201210338491.1 field in the Chinese Patent Office on Sep. 13, 2012 and entitle “SEARCHING METHOD, SYSTEM AND STORAGE MEDIUM”, the content of which is hereby incorporated by reference herein in its entirety.

### FIELD OF THE INVENTION

The present disclosure relates to a field of searching engine technology, and more specifically, to a searching method, a system, and storage medium.

### BACKGROUND OF THE INVENTION

With the development of Internet technology, more and more information can be obtained from the Internet, and people can obtain the information faster and more comprehensively. But as a result, it becomes more and more difficult to accurately find the information which is needed from the vast amounts of information. Searching engine is used to find the information which is needed from the Internet as accurately as possible, in order to improve the efficiency of obtaining information.

Currently, more and more users are using smart phones, and applications of the smart phone become more and more plentiful. When the user wants to use and call a special application, then a searching box is used for searching the application that the user wants. In current technology, after the user input one keyword in the searching box, a searching suggestion box is displayed to provide the user some searching suggestions. The contents of the searching suggestions are matched with an application name database, and the application name database has a good hint function for the user who does not know a full name of the application. The user can choose a searching suggestion of an application that the user wants, click the searching suggestion, enter a searching result page, then obtain and choose to enter a detail page of the application, which can reduce an input cost. However, steps of “choosing a searching suggestion—entering a searching result page—choosing to enter a detail page of the application” are complicated for the user who has a clear demand.

If the user can directly obtain application information from a searching result according to the searching suggestion, and enter a detail page of the application, a searching cost of the user can be reduced.

Some problems exist in the current technology. The problems are described in the following.

When information is searched by existing searching engines, generally there are two types of searching ways in the current technology.

One searching way is a non-searching suggestion feedback way which only provides a searching box, thus, when a keyword is input into the searching box by the user, any searching suggestion is not provided below the searching box.

Another searching way is a feedback way that provides searching suggestions with the same format. That is, when a keyword is input in the searching box by the user, a searching suggestion box is displayed below the searching box for providing searching suggestions. The contents of the searching suggestions are matched with an application name database. But each searching suggestion provided by the searching suggestion box has the same displaying format. When any searching suggestion is clicked by the user, a searching result page which uses the searching suggestion as a keyword is directly entered.

From above descriptions, there are the following disadvantages at the same time for the above two searching ways: a lot of searching results may be displayed by using of the searching engine, the searching results may be link information, but for purpose of obtaining detailed searching information, the user should further click the link information, which is unable to obtain and see an intuitive display result in a simple way and causes a complicated way when the user obtains required data.

### SUMMARY OF THE INVENTION

In the existing technology, the searching engine can generate and feed back a plurality of searching information, which may cause a complicated way for a user to obtain required data. Embodiments of the present invention provide a searching method and a searching system to solve the problem in the existing technology. Technology proposals of the searching method and the searching system are described as following.

A searching method of an embodiment is provided in present disclosure. The searching method includes the following steps.

Getting searching strings inputted by a user in real time.

Matching the searching strings with first keywords of a searching keyword hint database and second keywords of a through zone database respectively, wherein the searching keyword hint database includes plural first keywords, and the through zone database includes plural second keywords and data corresponding to the second keywords.

Displaying a predefined number of the first keywords and a predefined number of the second keywords matched with the searching strings to hint.

Displaying a searching result page matched with the first keyword, when any first keyword is chosen; displaying data matched with the second keyword in the through zone database, when any second keyword is chosen.

A searching system of an embodiment is provided in present disclosure. The searching system includes the following modules.

A getting module, configured to get searching strings inputted by the user in real time.

A matching module, configured to match the searching strings with first keywords of a searching keyword hint database and second keywords of a through zone database respectively, wherein the searching keyword hint database includes plural first keywords, and the through zone database includes plural second keywords and data corresponding to the second keywords.

A hinting module, configured to display a predefined number of the first keywords and a predefined number of the second keywords matched with the searching strings to hint.

A result displaying module, configured to display a searching result page matched with the first keyword, when any first keyword is chosen; and display data matched with the second keyword in the through zone database, when any second keyword is chosen.

A storage medium of an embodiment is provided in present disclosure. The storage medium storing instruction that, when executed by a computer, to implement a method including of the following steps.

Getting searching strings inputted by a user in real time.

Matching the searching strings with first keywords of a searching keyword hint database and second keywords of a through zone database respectively, wherein the searching keyword hint database includes plural first keywords, and the through zone database includes plural second keywords and data corresponding to the second keywords.

Displaying a predefined number of the first keywords and a predefined number of the second keywords matched with the searching strings to hint.

Displaying a searching result page matched with the first keyword, when any first keyword is chosen; displaying data matched with the second keyword in the through zone database, when any second keyword is chosen.

In the searching method and the searching system of the embodiment of present disclosure, a searching keyword hint database and a through zone database is preset, and the data is stored correspondingly with the keywords of the through zone database. On the one hand, the searching method and the searching system can provide a visual reminder to an input of the user. On the other hand, when the user searches a keyword, a through zone database is searched synchronously to obtain data corresponding to the keywords. When the searching engine feeds back and provides searching results, both of the data of the through zone database and the searching results are displayed to the user. In this way, the searching results can be directly obtained from the webpage of the searching engine, so that, there is no need to frequently click the link of each webpage on the webpage to search the searching result to search the searching result which is need, thereby improving a searching efficiency.

### BRIEF DESCRIPTION OF THE DRAWINGS

In order to make the embodiment of present disclosure or the embodiment of prior art more clearly, the drawings which are needed in the embodiment of present disclosure or the embodiment of prior art are described simply as follows. It is obviously, the drawings described as the follows are only embodiments of present disclosure. To a person of ordinary skill in the art, under premise of no creative work, other drawings may be obtained according to the drawings.

FIG. 1 is a flowchart of a searching method according to a first embodiment of present disclosure.

FIG. 2 is a flowchart of searching method according to a second embodiment of present disclosure.

FIG. 3 is a schematic diagram of the searching method according to the second embodiment searching in a searching front page of present disclosure.

FIG. 4 is a schematic diagram of the searching method according to the second embodiment searching in a searching result page of present disclosure.

FIG. 5 is a schematic diagram of a searching system according to a third embodiment of present disclosure.

FIG. 6 is a schematic diagram of a searching system according to a fourth embodiment of present disclosure.

### DETAILED DESCRIPTION OF ILLUSTRATED EMBODIMENTS

In order to make the purpose, the technical solution, and the advantages clearer, further description of the present invention will be illustrated, which combined with embodiments in the drawings.

The Searching result can be easily shown by a paragraph of character or a picture when the searching result required is obtained by the users by using the searching engine, which makes the searching way simple. Thus, if a preset through zone database is set, the paragraph of the character and the picture can be directly displayed by the webpage feedback by the searching engine. There is no need to frequently click the link of each webpage on the webpage to search the searching result which is need, thereby improving a searching efficiency. The embodiment of present invention can be applied to a searching engine for searching webpage, and it is examples of the embodiments of the present invention, and it is not used to limit the present invention.

Further description of present invention is illustrated combined with embodiments.

### A First Embodiment

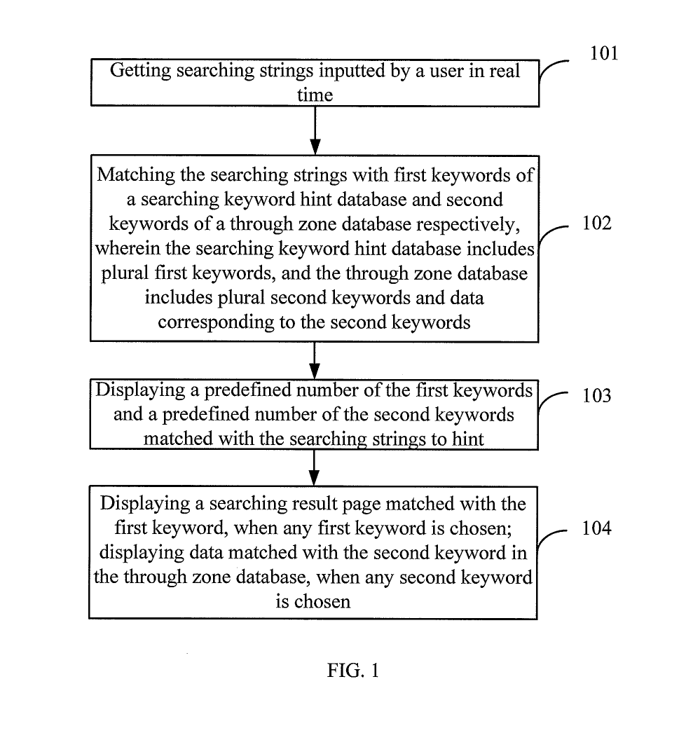

Referring to FIG. 1, FIG. 1 is a flowchart of a searching method according to a first embodiment of present disclosure. As shown in FIG. 1, the searching method includes the following steps.

Step 101, getting searching strings inputted by a user in real time.

Step 102, matching the searching strings with first keywords of a searching keyword hint database and second keywords of a through zone database respectively, wherein the searching keyword hint database includes plural first keywords, and the through zone database includes plural second keywords and data corresponding to the second keywords.

Step 103, displaying a predefined number of the first keywords and a predefined number of the second keywords matched with the searching strings to hint.

Step 104, displaying a searching result page matched with the first keyword, when any first keyword is chosen; displaying data matched with the second keyword in the through zone database, when any second keyword is chosen.

In the searching method of the embodiment of present disclosure, a searching keyword hint database and a through zone database is preset, and the data is stored correspondingly with the keywords of the through zone database. On the one hand, the searching method can provide a visual reminder to an input of the user. On the other hand, when the user searches a keyword, a through zone database is searched synchronously to obtain data corresponding to the keywords. When the searching engine feeds back and provides searching results, both of the data of the through zone database and the searching results are displayed to the user. In this way, the searching results can be directly obtained from the webpage of the searching engine, so that, there is no need to frequently click the link of each webpage on the webpage to search the searching result which is need, thereby improving a searching efficiency.

### A Second Embodiment

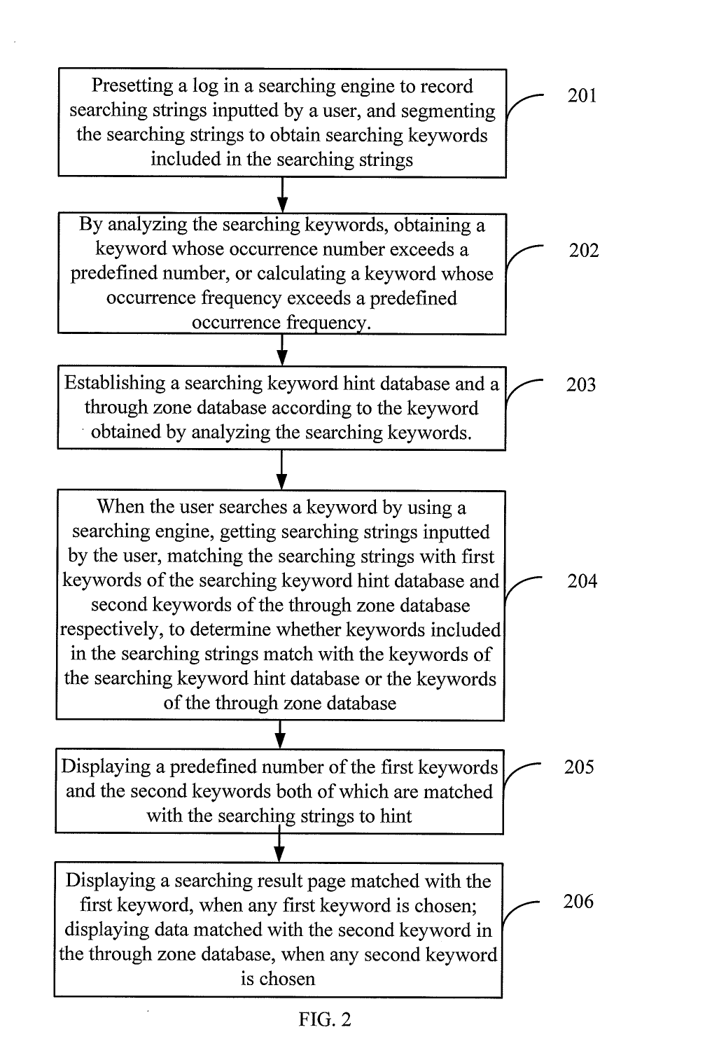

Referring to FIG. 2, FIG. 2 is a flowchart of searching method according to a second embodiment of present disclosure. The searching method of the second embodiment is obtained and improved on the basic of the searching method of the first embodiment. As shown in FIG. 2 the searching method at least includes the following steps.

Step 201, presetting a log in a searching engine to record searching strings inputted by a user, and segmenting the searching strings to obtain searching keywords included in the searching strings.

Each searching string input by the user can be a simply word, or a phrase, or a sentence. A searching keyword or plural searching keywords can be obtained after the searching string is segmented. Word segmentation technology is a mature technology in the existing technology. For example, in the word segmentation technology, an occurrence probability of a signal word or several words is/are calculated to determine whether the signal word or the several words is/are a term. If the signal word is determined to be a term, the signal word is segmented as a searching keyword. Detailed descriptions are no longer to repeat in the embodiment.

Step 202, by analyzing the searching keywords, obtaining a keyword whose occurrence number exceeds a predefined number, or calculating a keyword whose occurrence frequency exceeds a predefined occurrence frequency.

Step 203, establishing a searching keyword hint database and a through zone database according to the keyword obtained by analyzing the searching keywords.

The searching keyword hint database includes plural first keywords, and the through zone database includes plural second keywords and data corresponding to the second keywords. The data can be but not limited to: characters and/or pictures, or links of characters and/or pictures. It should be understood that the first keywords of the searching keyword hint database are different from the second keywords of the through zone database, as so to provide differentiated prompt action. In detail, the first keyword is configured to hint the user to search, and the second keyword is configured to guide the user to directly obtain the data of the through zone database.

In the embodiment, the second keywords can be, such as, application (app) names. The data can include ICONs of the applications, product names, download times, view details, stars, etc.

Step 204, when the user searches a keyword by using a searching engine, getting searching strings inputted by the user, matching the searching strings with first keywords of the searching keyword hint database and second keywords of the through zone database respectively, to determine whether keywords included in the searching strings match with the keywords of the searching keyword hint database or the keywords of the through zone database.

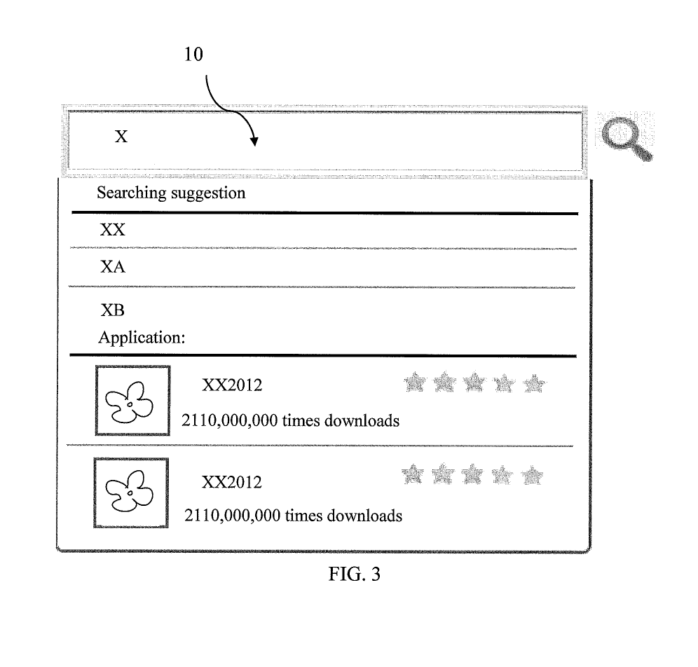

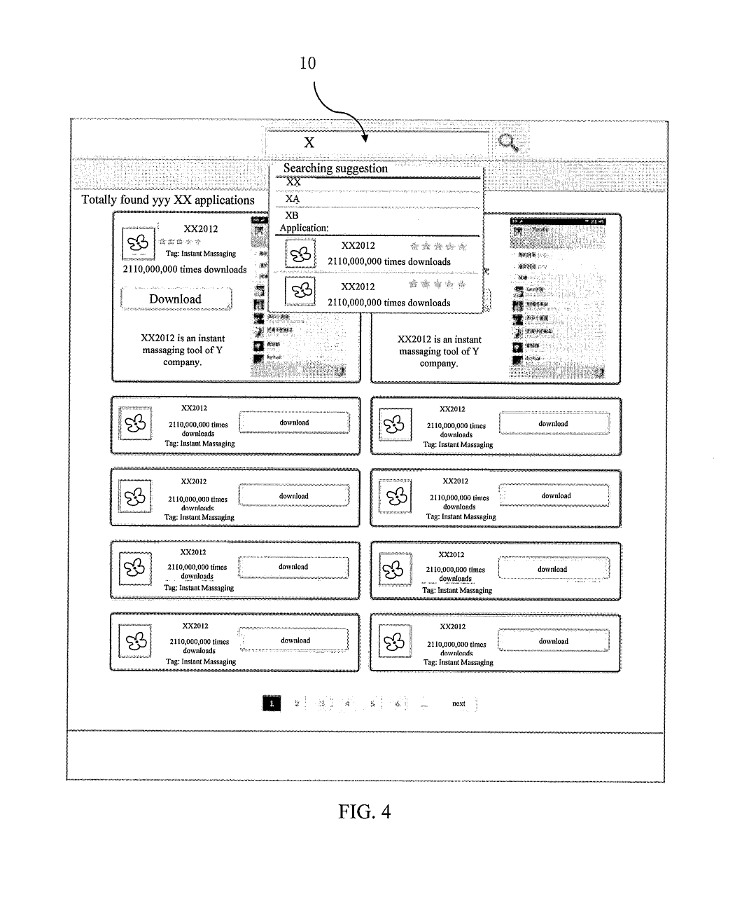

Referring to FIG. 3 and FIG. 4, in the embodiment, the user inputs a letter “X” as a searching string in the searching box 10 on the homepage of a searching page of FIG. 3 or in the searching box 10 on a searching result page of FIG. 4, at least three first keywords are searched in the searching keyword hint database and are matched with the searching strings X input by the user. Three of the at least three first keywords are: XX, XA, and XB. At least one second keyword is searched in the through zone database and is matched with the searching strings X input by the user, one of the at least one second keyword is XX2012.

It should be noted that, in the embodiment, matching the searching strings with first keywords of the searching keyword hint database and second keywords of the through zone database respectively includes: when the searching string is a Chinese character, searching the first keywords and the second keywords which begin with the searching string. For example, when a Chinese character “ [symbol] ” is input in the searching box 10 by the user, the first keywords and the second keywords begin with the character sing include “ [symbol] K”, “ [symbol] ”, “ [symbol] ”, etc. When the searching string is a letter, searching the first keywords and the second keywords including the letter, or converting the letter or letters into high frequency words, and searching the first keywords and the second keywords that are matched with the high frequency words. In practical application, the high frequency word is a word which has more occurrence times and higher frequency of use and can be obtained in a high frequency words database, and the high frequency words database includes high frequency words corresponding to each letter, and scores corresponding to each high frequency word. For example, when a letter “I” is input in the searching box 10 by the user, the high frequency words corresponding to the letter “I” can be found in the high frequency database, and several high frequency words with higher scores are chosen from all the high frequency words, and searching the first keywords and the second keywords that are matched with the high frequency words with higher scores. The several high frequency words may be such as “think”, “iphone”.

Step 205, displaying a predefined number of the first keywords and the second keywords both of which are matched with the searching strings to hint.

In the embodiment, three first keywords and two second keywords are displayed to hint, and the first keywords are arranged in front of the second keywords. In detail, the three first keywords include: XX, XA, XB, and both of the two second keywords are XX2012. It should be understood that the first keywords and the second keywords are determined according to the actual need, but not limited to the detailed embodiment. For example, the number of the first keywords displayed can also be: two, five, six, or other number. The number of the second keywords displayed can also be: one, three, four, or other number. In addition, the first keywords can be the same as the second keywords, or each first keyword can be different with each other as mentioned in the embodiment.

In the embodiment, when the first keywords or the second keywords are application names, plural first keywords or plural second keywords are sequenced according to the downloads in the reverse order, and the downloads of the second keywords can be displayed through a visual identification. For example, in the embodiment, downloads of the XX2012 displayed through a visual identification are 21.1 million times. Moreover, when the first keywords or the second keywords are the high frequency words, plural first keywords or plural second keywords are sequenced in turn according to score of the high frequency words, such as scored high to low, or scored low to high. In the embodiment, the plural first keywords are arranged in front of the plural second keywords. It should be understood that in other embodiments, the plural first keywords can be arranged behind the plural second keywords. That is, the orders of the first keywords and the second keywords are not limited to the detailed embodiments of present disclosure.

Step 206, displaying a searching result page matched with the first keyword, when any first keyword is chosen; displaying data matched with the second keyword in the through zone database, when any second keyword is chosen.

In detail, when a first keyword is chosen, a sever feeds back a searching result page matched with the first keyword. When a second keyword is chosen, the data corresponding to the second keyword is set on the top of a feedback page, and the searching result is set bellow the data to generate the feedback page. The feedback page is sent to a terminal, and is further displayed on the terminal. As shown in FIG. 4, when the second keyword is chose, the data matched with the second keyword is displayed. In detail, the second keywords can be, such as, application (app) names. The data can include ICONs of the applications, product names, download times, view details, stars, etc.

In this method, the data stored in the through zone database can be directly displayed to the user. When the user searches a keyword by use of a searching engine, a searching result can be obtained by means of an existing way, at the same time, the data of the through zone data base is displayed to the user together with the searching result. Because the data of the through zone database is character and/or picture, so there is no need for the user to click a uniform resource locator (URL) link, and the information can be directly obtained, which improves a searching efficiency. Even if the data in the through zone database are not the messages that the user needs, other searching results can also be obtained by use of the existing way in the embodiment of the present disclosure, so the user can continue to search the keyword according to the existing way to obtain the data.

For breaking news or other hot news, searching requests with the same or similar keywords are frequently received within a short time by the searching engine. The searching requests are hot keywords within the short period of time. Thus, the searching method of the embodiment can further include the following steps.

Step A, analyzing a preset log to obtain keywords whose occurrence number exceeds a predefined number, or calculating a keyword whose occurrence frequency exceeds a predefined occurrence frequency.

Step B, adding the keywords and the data corresponding to the keywords to the through zone database. When the keywords are searched by the user, the keywords are displayed to the user by means of the above steps.

Further, in order to keep the reliability of the data, the searching method of the embodiment further includes the following step.

Step C, updating the through zone database in real time. Contents to be updated in real time includes searching keywords obtained by searching the log, correctness of the data (such as characters, pictures) in the through zone database, and effectiveness of the URL.

The searching method in the embodiment of present disclosure obtains keywords having a higher frequency by analyzing the searching strings, and analyzes whether the searching results corresponding to the keywords are changed over time. Then the searching results can be obtained by use of different ways according to the features of the keywords, and be stored into the through zone database. When the searching results are displayed, both of the data in the through zone database and the searching results searched by an ordinary searching engine are displayed to the user together. Thus, even if the data in the through zone database are not the messages that the user needs, too much waste of system overhead and network resource will not occur. When the user enters a search, all the needed searching results can be appeared in the webpage of the searching engine by a picture and/or a paragraph of characters. Thus, the user does not need to frequently click the links of the webpage from the searching results to obtain the data which needs by the user, which greatly improve searching efficiency.

### A Third Embodiment

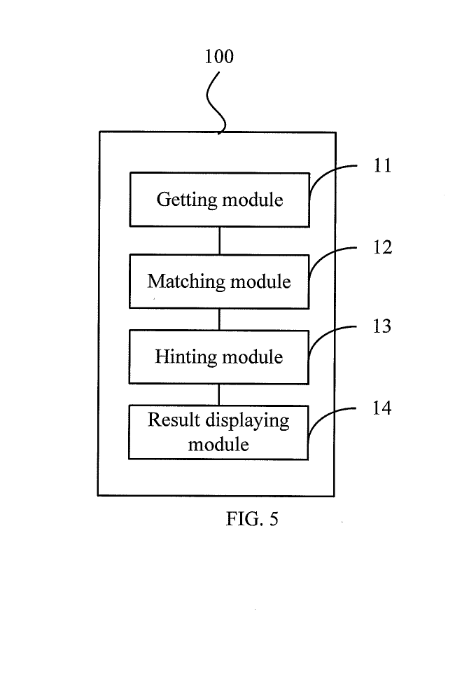

Referring to FIG. 5, FIG. 5 is a schematic diagram of a searching system according to a third embodiment of present disclosure. As shown in FIG. 5, the searching system 100 includes the following modules.

A getting module 11 is configured to get searching strings inputted by the user in real time.

A matching module 12 is configured to match the searching strings with first keywords of a searching keyword hint database and second keywords of a through zone database respectively, wherein the searching keyword hint database includes plural first keywords, and the through zone database includes plural second keywords and data corresponding to the second keywords.

A hinting module 13 is configured to display a predefined number of the first keywords and a predefined number of the second keywords matched with the searching strings to hint.

A result displaying module 14 is configured to display a searching result page matched with the first keyword, when any first keyword is chosen; and display data matched with the second keyword in the through zone database, when any second keyword is chosen.

In the searching system of the embodiment of present disclosure, a searching keyword hint database and a through zone database is preset, and the data is stored correspondingly with the keywords of the through zone database. On the one hand, the searching system can provide a visual reminder to an input of the user. On the other hand, when the user searches a keyword, a through zone database is searched synchronously to obtain data corresponding to the keywords. When the searching engine feeds back and provides searching results, both of the data of the through zone database and the searching results are displayed to the user. In this way, the searching results can be directly obtained from the webpage of the searching engine, so that, there is no need to frequently click the link of each webpage from the searching result to search the searching result which is need, thereby, improving a searching efficiency.

### A Fourth Embodiment

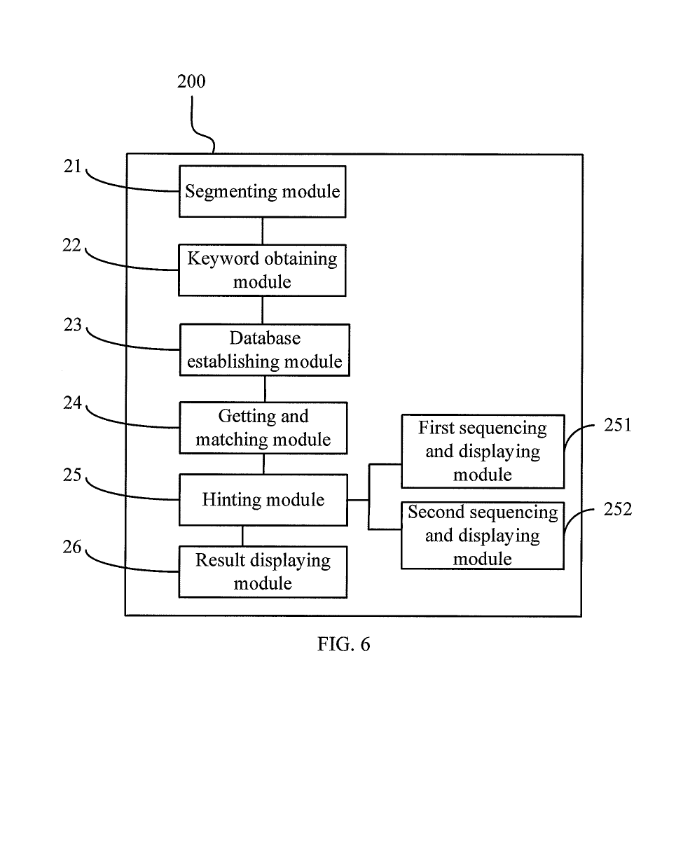

Referring to FIG. 6, FIG. 6 is a schematic diagram of a searching system according to a fourth embodiment of present disclosure. The searching system of the fourth embodiment is obtained by improving on base of the searching system of the third embodiment. As shown in FIG. 6, the searching system 200 includes the following modules.

A segmenting module 21 is configured to preset a log in a searching engine to record searching strings inputted by a user, and configured to segment the searching strings to obtain searching keywords included in the searching strings. The segmentation technology is a mature technology in current technology, please refer to paragraph [0048], and it is not repeat in the embodiment.

A keyword obtaining module 22 is configured to obtain a keyword whose occurrence number exceeds a predefined number by analyzing the searching keywords, or calculate a keyword whose occurrence frequency exceeds a predefined occurrence frequency.

A database establishing module 23 is configured to establish a searching keyword hint database and a through zone database according to the keyword obtained by analyzing the searching keywords. The searching keyword hint database includes plural first keywords, and the through zone database includes plural second keywords and data corresponding to the second keywords. The data can be but not limited to: characters, or/and pictures, or links of characters and/or pictures. It should be understood that the first keywords of the searching keyword hint database are different from the second keywords of the through zone database, so as to provide differentiated prompt action. In detail, the first keyword is configured to hint the user to search, and the second keyword is configured to guide the user to directly obtain the data of the through zone database.

A getting and matching module 24 is configured to get searching strings inputted by the user, and match the searching strings with first keywords of the searching keyword hint database and second keywords of the through zone database respectively, to determine whether the keywords included in the searching strings match with the keywords of the searching keyword hint database or the keywords of the through zone database, when a user searches by using a searching engine.

A hinting module 25 is configured to display a predefined number of the first keywords and the second keywords both of which are matched with the searching strings to hint. The searching system 200 of the embodiment further include a first sequencing and displaying module 251, and a second sequencing and displaying module 252. The first sequencing and displaying module 251 is configured to sequence plural first keywords or plural second keywords according to the downloads in the reverse order, when the first keywords or the second keywords are application names. Downloads of the second keywords can be displayed through a visual identification. For example, in the embodiment, downloads of the XX2012 displayed through a visual identification are 21.1 million times. The second sequencing and displaying module 252 is configured to sequence plural first keywords or plural second keywords in turn according score of high frequency words (such as scored high to low, or scored low to high), when the first keywords or the second keywords are high frequency words.

A result displaying module 26 is configured to display a searching result page matched with the first keyword, when any first keyword is chosen; and display data matched with the second keyword in the through zone database, when any second keyword is chosen.

In detail, when a first keyword is chosen, a sever feeds back a searching result page matched with the first keyword. When a second keyword is chose, the data corresponding to the second keyword is set on the top of a feedback page, and the searching result is set bellow the data to generate the feedback page. The feedback page is sent to a terminal, and is further displayed on the terminal.

In this method, the data stored in the through zone database can be directly displayed to the user. When the user searches a keyword by use of a search engine, a searching result can be obtained by means of an existing way, at the same time, the data of the through zone data base is displayed to the user together with the searching result. Because the data of the through zone database is character and/or picture, so there is no need for the user to click a uniform resource locator (URL) link, and the information can be directly obtained, which improves a searching efficiency. Even if the data in the through zone database are not the messages that the user needs, other searching result can also be obtained by use of the existing way in embodiment of present disclosure, so the user can continue to search the keyword according to the existing way to obtain the data.

For breaking news or other hot news, searching requests with the same or similar keywords are frequently received within a short time by the searching egine. The searching requests are hot keywords within the short period of time. Thus, the searching system of the embodiment can further include the following modules (not shown).

A keyword calculating module is configured to analyze a preset log to obtain keywords whose occurrence number exceeds a predefined number, calculating a keyword whose occurrence frequency exceeds a predefined occurrence frequency.

A data adding module is configured to add the keywords and the data corresponding to the keywords to the through zone database. When the keywords are searched by the user by means of the above steps.

Further, in order to keep the reliability of the data, the searching system of the embodiment further includes the following module.

A database updating module is configured to update the through zone database in real time. Contents to be updated in real time includes searching keywords obtained by searching the log, correctness of the data (such as characters, pictures) in the through zone database, and effectiveness of the URL.

The searching system in the embodiment of present disclosure obtains keywords having a higher frequency by analyzing the searching strings, and analyzes whether the searching results corresponding to the keywords are changed over time. Then the searching results can be obtained by use of different ways according to the features of the keywords, and be stored into the through zone database. When the searching results are displayed, both of the data in the through zone database and the searching results searched by an ordinary searching engine are displayed to the user together. Thus, even if the data in the through zone database are not the messages that the user needs, too much waste of system overhead and network resource will not occur. When the user enters a search, all the needed searching results can be appeared in the webpage of the searching engine by a picture and/or a paragraph of characters. Thus, the user does not need to frequently click the links of the webpage from the searching results to obtain the data which needs by the user, which greatly improve searching efficiency.

A conception and a principle of the searching system described in the third embodiment and the fourth embodiment are the same with the conception and the principle of the searching method described in the first embodiment and the second embodiment. Thus, the parts of the third embodiment and the fourth embodiment being the same with the parts of the first embodiment and the second embodiment are not repeated here.

If the integrated modules of the embodiments are realized in form of software module, sold, and used as an individual product, the modules of the embodiments can be stored in a computer readable storage medium. The technical proposal of the present disclosure or the parts making a contribution to current technology can be realized in form of software product. The software product is stored in a storage medium. The storage medium includes some instructions to let a computer device (such as a personal computer, a server, or a network device) implement part of or all of the steps of the method of present disclosure. The storage medium may be medium which can storage programs. The storage medium can be U disk, a mobile hard disk, read-only memory (ROM), random assess memory (RAM), disk, compact disk.

While the present disclosure has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

It is important to point that, to program codes executed by computer, an operation of at least part of the program codes can be realized by an operation system of the computer to realize the technology proposal of each embodiment of present disclosure. The computer implements instruction on base of program codes.

Further, the program codes of the storage medium are written into storage. The storage locates on an extension board of the computer, or an extension module connected to the computer. The central processing unit (CPU) of the extension board or the extension module implements at least some operation to realize the technology proposal of each embodiment described above. The CPU implements at least the operation on base of program codes.

What is claimed is:

1. A searching method, comprising:
getting searching strings inputted by a user in real time;
matching the searching strings with first keywords of a searching keyword hint database and second keywords of a through zone database respectively, wherein the searching keyword hint database includes plural first keywords, and the through zone database includes plural second keywords and data corresponding to the second keywords;
displaying a predefined number of the first keywords and a predefined number of the second keywords matched with the searching strings to hint; and
displaying a searching result page matched with the first keyword, when any first keyword is chosen; displaying data matched with the second keyword in the through zone database, when any second keyword is chosen.

2. The searching method according to claim 1, wherein the step of matching the searching strings with first keywords of a searching keyword hint database and second keywords of a through zone database respectively comprising:
when the searching string is a Chinese character, searching the first keywords and the second keywords which begin with the searching string;
when the searching string is a letter, searching the first keywords and the second keywords including the letter, or converting the letter or letters into high frequency words, and searching the first keywords and the second keywords that are matched with the high frequency words.

3. The searching method according to claim 1, wherein when the first keywords or the second keywords are application names, plural first keywords or plural second keywords are sequenced according to the downloads in the reverse order.

4. The searching method according to claim 3, wherein downloads of the second keywords can be displayed through a visual identification.

5. The searching method according to claim 2, wherein when the first keywords or the second keywords are the high frequency words, plural first keywords or plural second keywords are sequenced in turn according to score of the high frequency words.

6. The searching method according to claim 1, wherein before the step of getting searching strings inputted by a user in real time, the method further comprises:
presetting a log in a searching engine to record searching strings inputted by a user, and segmenting the searching strings to obtain searching keywords included in the searching strings;
analyzing the searching keywords, and obtaining a keyword whose occurrence number exceeds a predefined number, or calculating a keyword whose occurrence frequency exceeds a predefined probability occurrence frequency; and
establishing a searching keyword hint database and a through zone database according to the keyword obtained by analyzing the searching keywords.

7. A searching system, comprising:
a getting module, configured to get searching strings inputted by the user in real time;
a matching module, configured to match the searching strings with first keywords of a searching keyword hint database and second keywords of a through zone database respectively, wherein the searching keyword hint database includes plural first keywords, and the through zone database includes plural second keywords and data corresponding to the second keywords;
a hinting module, configured to display a predefined number of the first keywords and a predefined number of the second keywords matched with the searching strings to hint; and
a result displaying module, configured to display a searching result page matched with the first keyword, when any first keyword is chosen; and display data matched with the second keyword in the through zone database, when any second keyword is chosen.

8. The searching system according to claim 7, wherein the matching module is further configured to:
when the searching string is a Chinese character, search the first keywords and the second keywords begin with the searching string;
when the searching string is a letter, search the first keywords and the second keywords including the letter, or convert the letter or letters into high frequency words, and search the first keywords and the second keywords that are matched with the high frequency words.

9. The searching system according to claim 7, further comprising:
a first sequencing and displaying module, configured to sequence plural first keywords or plural second keywords according to the downloads in the reverse order, when the first keywords or the second keywords are application names.

10. The searching system according to claim 9, wherein downloads of the second keywords be displayed through a visual identification.

11. The searching system according to claim 8, further comprising:
a second sequencing and displaying module, configured to sequence plural first keywords or plural second keywords in turn according to score of high frequency words, when the first keywords or the second keywords are high frequency words.

12. The searching system according to claim 7, further comprising:
a segmenting module, configured to preset a log in a searching engine to record searching strings inputted by a user, and configured to segment the searching strings to obtain searching keywords included in the searching strings;
a keyword obtaining module, configured to obtain a keyword whose occurrence number exceeds a predefined number by analyzing the searching keywords, or calculate a keyword whose occurrence frequency exceeds a predefined occurrence frequency; and
a database establishing module, configured to establish a searching keyword hint database and a through zone database according to the keyword obtained by analyzing the searching keywords.

13. A storage medium storing instruction that, when executed by a computer, to implement a method comprising steps of:
getting searching strings inputted by a user in real time;
matching the searching strings with first keywords of a searching keyword hint database and second keywords of a through zone database respectively, wherein the searching keyword hint database includes plural first keywords, and the through zone database includes plural second keywords and data corresponding to the second keywords;
displaying a predefined number of the first keywords and a predefined number of the second keywords matched with the searching strings to hint; and
displaying a searching result page matched with the first keyword, when any first keyword is chosen; displaying data matched with the second keyword in the through zone database, when any second keyword is chosen.

14. The storage medium according to claim 13, wherein the step of matching the searching strings with first keywords of a searching keyword hint database and second keywords of a through zone database respectively comprising:
when the searching string is a Chinese character, searching the first keywords and the second keywords which begin with the searching string;
when the searching string is a letter, searching the first keywords and the second keywords including the letter, or converting the letter or letters into high frequency words, and searching the first keywords and the second keywords that are matched with the high frequency words.

15. The storage medium according to claim 13, wherein when the first keywords or the second keywords are application names, plural first keywords or plural second keywords are sequenced according to the downloads in the reverse order.

16. The storage medium according to claim 15, wherein downloads of the second keywords can be displayed through a visual identification.

17. The storage medium according to claim 14, wherein when the first keywords or the second keywords are the high frequency words, plural first keywords or plural second keywords are sequenced in turn according to score of the high frequency words.

18. The storage medium according to claim 13, wherein before the step of getting searching strings inputted by a user in real time, the method further comprises:
presetting a log in a searching engine to record searching strings inputted by a user, and segmenting the searching strings to obtain searching keywords included in the searching strings;
analyzing the searching keywords, and obtaining a keyword whose occurrence number exceeds a predefined number, or calculating a keyword whose occurrence frequency exceeds a predefined probability occurrence frequency; and
establishing a searching keyword hint database and a through zone database according to the keyword obtained by analyzing the searching keywords.
